(19) United States
(12) Patent Application Publication
(10) Pub. No.: US 2025/0190773 A1
(43) Pub. Date: Jun. 12, 2025

(54) NEURAL NETWORK-BASED CONTROL METHOD FOR SWITCHING CONDUCTION MODE OF BUCK CONVERTER

(71) Applicant: Guangdong Ocean University, Zhanjiang City (CN)

(72) Inventors: Liming ZHAO, Zhanjiang City (CN); Bing ZHANG, Zhanjiang City (CN); Peng LUO, Zhanjiang City (CN); Haoyu JIANG, Zhanjiang City (CN); Haisheng CHEN, Zhanjiang City (CN)

(21) Appl. No.: 18/949,030

(22) Filed: Nov. 15, 2024

(30) Foreign Application Priority Data
Dec. 7, 2023 (CN) 202311674687.2

(51) Int. Cl. G06N 3/063; G06N 3/084; H02M 3/157

(52) U.S. Cl. CPC G06N 3/063; G06N 3/084; H02M 3/157

(57) ABSTRACT

Provided is a neural network-based control method for switching a conduction mode of a Buck converter, including: establishing a state-space averaging model of the Buck converter, acquiring and substituting output voltages and inductive currents of the Buck converter in a discontinuous conduction mode (DCM) and a continuous conduction mode (CCM) into a state equation, and obtaining a precise state model under different working conditions; performing an explicit model predictive control (EMPC) design to generate a visual control law distribution diagram; obtaining neural network output through forward propagation, and comparing the neural network output with an optimal duty cycle obtained through EMPC, to obtain an error; performing fitting on the EMPC design, and completing offline training; and extracting a parameter of the trained neural network to a field programmable gate array (FPGA), and performing weighted summation calculation on input data, to obtain a duty cycle required for controlling the Buck converter.

### CROSS REFERENCE TO RELATED APPLICATION

This patent application claims the benefit and priority of Chinese Patent Application No. 202311674687.2, filed with the China National Intellectual Property Administration on Dec. 7, 2023, the disclosure of which is incorporated by reference herein in its entirety as part of the present application.

### TECHNICAL FIELD

The present disclosure belongs to the field of power electronic converter control technologies, and in particular to a neural network-based control method for switching a conduction mode of a Buck converter.

### BACKGROUND

With continuous development of the modern power electronics technology, Buck converters are widely used in a plurality of fields such as energy, LED drive, and aerospace, and are important direct-current buck power electronic power supplies. To meet an actual need of quickly starting up a high-power load, the Buck converter needs to have a high dynamic response capability for swinging from a discontinuous conduction mode (DCM) to a continuous conduction mode (CCM). The PI control is a common policy for controlling a DC-DC converter because of its simple control structure and low cost. When the converter switches between the CCM and the DCM, its anti-interference capability is poor, not meeting a high-performance control requirement. In the conventional technology, most DC-DC converters are used in a single working condition. For example, precision of an output ripple voltage of the Buck converter is improved through mathematical modeling, or steady-state operation of the Buck converter in the DCM is achieved through digital circuit detection. Both the forgoing manners are converter control manners in a single CCM or DCM working condition, and a case of switching between the two modes is not discussed. In the conventional technology, although the working condition of the Buck converter during DCM/CCM switching is discussed, control of the Buck converter is complex, and therefore, the Buck converter needs to be switched between the two control manners. In the conventional technology, a current state of a high dynamic requirement of a Buck converter in a DCM/CCM working condition switching process is that a voltage overshoot is large, and response time is excessively long in the switching process. Therefore, a neural network-based control method for switching a conduction mode of a Buck converter needs to be urgently proposed.

### SUMMARY

To resolve the technical problem, the present disclosure discloses a neural network-based control method for switching a conduction mode of a Buck converter, to effectively improve precision of an output voltage of the Buck converter during DCM/CCM switching, and have short time for achieving a steady state, and a large overshoot.

To achieve the objective, the present disclosure provides a neural network-based control method for switching a conduction mode of a Buck converter, including:
S1, establishing a state-space averaging model of the Buck converter, acquiring and substituting output voltages vₒ and inductive currents i_{L} of the Buck converter in a DCM and a CCM into a state equation, and obtaining, based on a characteristic of a discrete equation and a backward propagation characteristic of a neural network, a precise state model under different working conditions;
S2, performing an explicit model predictive control (EMPC) design based on the state model for dynamic performance of the Buck converter to be optimal, to generate a visual control law distribution diagram;
S3, acquiring visual control laws in the DCM and the CCM as training data of a second neural network, obtaining neural network output through forward propagation by taking [i_{L}, vₒ, iₒ, V_{ref}] as neural network input, and comparing the neural network output with an optimal duty cycle d^{opt}(g+l|g) obtained through EMPC, to obtain an error;
S4, performing fitting on the EMPC design through the second neural network, and completing offline training of the second neural network when the error continuously decreases to be within an allowable error range, to generate a neural network controller; and
S5, in real-time control, extracting a parameter of the neural network controller to a field programmable gate array (FPGA), performing weighted summation calculation on real-time input data [i_{L}, vₒ, iₒ, V_{ref}] when switching the conduction mode, and performing, by the neural network controller based on state sampling, online adjustment on the duty cycle, to obtain a duty cycle required for controlling the Buck converter.

Optionally, an expression formula of the state equation in step S1 is as follows:

$$[ \begin{matrix}{i}_{L} ( g + 1 ) \\ {v}_{o} ( g + 1 )\end{matrix} ] = [ \begin{matrix}{a}_{11} & {a}_{12} \\ {a}_{21} & {a}_{22}\end{matrix} ] [ \begin{matrix}{i}_{L} ( g ) \\ {v}_{o} ( g )\end{matrix} ] + [ \begin{matrix}{b}_{1} \\ {b}_{2}\end{matrix} ] d ( g )$$

Herein, i_{L}(g) and vₒ(g) respectively represent an inductive current and an output voltage at a moment g, i_{L}(g+1), vₒ(g+1), and d(g+1) respectively represent an inductive current, an output voltage, and a duty cycle at a moment g+1, and a₁₁, a₁₂, a₂₁, a₂₂, b₁, and b₂ are state coefficients of the state equation.

Optionally, the obtaining, based on a characteristic of a discrete equation and a backward propagation characteristic of a neural network, a precise state model under different working conditions includes:
inputting the inductive current, the output voltage, and the duty cycle into the neural network, defining the state coefficient as a weight of the neural network, obtaining output of a first neural network, performing linear operation on the input and the output, constructing an error function, and adjusting the error function to be within a specified range through backward propagation, to obtain the precise state model under different working conditions.

Optionally, a control objective for performing the EMPC design on different models is to adjust vₒ to a reference voltage V_{ref}, and a target function is defined as follows:

$${J}_{min} = {\sum }_{l = 0}^{L - 1} {q}_{1} [ {( {V}_{r e f} - {v}_{o} ( g + l \vert g ) )}^{2} + {q}_{2} {{i}_{L} ( g + l \vert g )}^{2} ]$$

Herein, L is a prediction period, q₁ and q₂ are penalty coefficients that are configured to fine-tune a dynamic control process, and vₒ(g+l|g) and i_{L}(g+l|g) represent prediction values at the moment g.

Optionally, a corresponding constraint condition for a state variable and a control parameter during the EPMC design includes:

$$0 \leq {i}_{L} ( g ) \leq {I}_{L max}$$

$$0 \leq {v}_{o} ( g ) \leq {V}_{o max}$$

$$0 \leq d ( g ) \leq 1$$

Herein, i_{L}(g), vₒ(g), and d(g) respectively represent the inductive current, the output voltage, and the duty cycle at the moment g.

Optionally, a process of obtaining neural network output through forward propagation by taking [i_{L}, vₒ, iₒ, V_{ref}] as neural network input includes:
at an input layer: before introducing [i_{L}(g), vₒ(g), iₒ(g), V_{ref} (g)] into the second neural network, normalizing input data as xₘ(j)(m=1, 2, 3, 4) which is represented as

$${x}_{m} ( j ) = \frac{2 x - 2 {X}_{min}}{{X}_{max} - {X}_{min}} - 1 ,$$

where X is an actual value in one-dimensional input, Xₘₐₓ is a maximum value in one-dimensional input, and Xₘᵢₙ is a minimum value in one-dimensional input;
at a hidden layer: performing, by a neuron at the hidden layer, linear operation, namely, weighted summation calculation, on the input, transferring a linear operation result to a nonlinear activation function to obtain output at the hidden layer:

$${O}_{h} = φ ( {\sum }_{k = 1}^{n} {w}_{i j} {x}_{m} ( j ) + {B}_{i j} ) ,$$

where wᵢⱼ represents a weight between a j^{th} neuron at the input layer and an i^{th} neuron at the hidden layer, and Bᵢⱼ represents a bias between the j^{th} neuron at the input layer and the i^{th} neuron at the hidden layer; and
at an output layer: firstly performing weighted summation calculation on the output at the hidden layer, and then using the activation function φ(x) to obtain output at the output layer:

$${O}_{out} = φ ( {\sum }_{k = 1}^{n} {w}_{l i} {O}_{h} + {B}_{l i} ) ,$$

where wₗᵢ represents a weight between the i^{th} neuron at the hidden layer and a l^{th} neuron at the output layer, and B₁ᵢ represents a bias between the i^{th} neuron at the hidden layer and the l^{th} neuron at the output layer; and
both the activation functions at the hidden layer and the output layer are ReLU functions, so that a few resources are occupied by a digital controller, and an expression formula of the ReLU function is:

$$ReLU ( x ) = \{ \begin{matrix}0 & x \leq 0 \\ x & x > 0\end{matrix} , x$$

Herein, x is data obtained through weighted summation at the hidden layer or the output layer.

Optionally, the weight and the bias are corrected through a gradient descent method and a chain rule, and the completing offline training of the second neural network when the error continuously decreases to be within an allowable error range includes:
defining the error function as:

$${E}_{o f f} = {[ {d}^{o p t} ( g + 1 \vert g ) - {D}_{N N} ( g + 1 \vert g ) ]}^{2} ,$$

Herein d^{opt}(g+1|g) is the optimal duty cycle obtained through the EMPC, D_{NN}(g+1|g) is a neural network output value, the weight and the bias of the neural network are adjusted layer by layer through the gradient descent method from the input layer to the output layer, d^{opt}(g+1|g) and D_{NN}(g+1|g) are compared to obtain the error function E(k) according to the chain rule:

$$\frac{\partial E ( k )}{\partial w} = \frac{\partial E ( k )}{\partial τ} \cdot \frac{\partial τ}{\partial w}$$

where τ is the activation function at the hidden layer or the output layer; and
an obtained gradient is multiplied with a learning rate λ, to update the original weight w as:

$$w ( j + 1 ) = w ( j ) - λ \frac{\partial E ( k )}{\partial w}$$

In the formula, w(j+1) and w(j) respectively represent weights at a moment j+1 and a moment j, the learning rate λ determines a step size for weight update, that is, during each iteration, an amplitude of the weight is adjusted in the network based on a gradient of a loss function.

The present disclosure has the technical effects: According to the neural network-based control method for switching a conduction mode of a Buck converter disclosed in the present disclosure, a Buck converter structural model is firstly established by using a control policy of fitting the neural network and the EMPC. Constraints are added to the model under the DCM and CCM working conditions to obtain an optimal prediction solution. EMPC laws of the converter under different working conditions are combined as a training sample of the neural network, and then the neural network is trained. After specific fitting precision is achieved, the converter can be controlled in real time through the neural network, and can be quickly adjusted to a given state when a system parameter changes. In the present disclosure, precision of an output voltage of the Buck converter during DCM/CCM switching is effectively improved, time for achieving a steady state is short, and an overshoot is small.

### BRIEF DESCRIPTION OF THE DRAWINGS

The drawings constituting part of the present application are provided for further understanding of the present application. The illustrative examples of the present application and description thereof are intended to explain the present application, rather than to constitute an improper limitation to the present application. In the accompanying drawings:

FIG. 1 is schematic flowchart of a neural network-based control method for switching a conduction mode of a Buck converter according to an embodiment of the present disclosure;

FIG. 2 is a schematic diagram of a topological structure of a Buck converter according to an embodiment of the present disclosure;

FIG. 3 is a flowchart of propagation of a first neural network according to an embodiment of the present disclosure;

FIGS. 4A-4B are schematic diagrams of a control rule and a prediction effect of an EMPC according to an embodiment of the present disclosure, where FIG. 4A is a schematic diagram of the control rule of the EMPC, and FIG. 4B is a schematic diagram of the prediction effect of the EMPC;

FIGS. 5A-5B are schematic diagrams of EMPC rates at different working points according to an embodiment of the present disclosure;

FIG. 6 is a schematic diagram of integrating control rates in different working conditions according to an embodiment of the present disclosure;

FIG. 7 is a schematic diagram of a propagation process of a second neural network according to an embodiment of the present disclosure;

FIGS. 8A-8B are simulation diagrams of an output voltage and an inductive current according to an embodiment of the present disclosure, where FIG. 8A is a simulation diagram of an output voltage and an inductive current in CCM-DCM-CCM, and FIG. 8B is a simulation diagram of an output voltage and an inductive current in DCM-CCM-DCM; and

FIG. 9 shows offline and online implementation processes of a neural network according to the present disclosure.

### DETAILED DESCRIPTION OF THE EMBODIMENTS

It should be noted that the embodiments in the present disclosure and features in the embodiments may be combined with each other in a non-conflicting situation. The present disclosure will be described in detail below with reference to the drawings and embodiments.

It should be noted that, steps shown in the foregoing process or the flowchart in the accompanying drawings may be executed in a computer system such as a set of computer executable instructions. Moreover, although a logic sequence is shown in the flowchart, the shown or described steps may be executed in a sequence different from that described here.

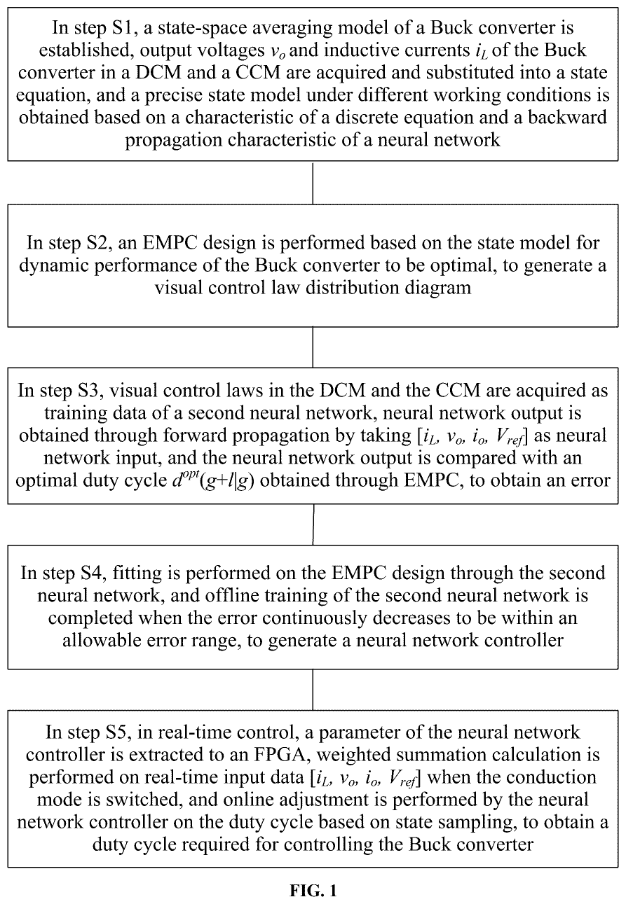

As shown in FIG. 1, in an embodiment, a neural network-based control method for switching a conduction mode of a Buck converter is provided, including the following steps.
In step S1, a state-space averaging model of the Buck converter is established, output voltages vₒ and inductive currents i_{L} of the Buck converter in a DCM and a CCM are acquired and substituted into a state equation, and a precise state model under different working conditions is obtained based on a characteristic of a discrete equation and a backward propagation characteristic of a neural network.
In step S2, an EMPC design is performed based on the state model for dynamic performance of the Buck converter to be optimal, to generate a visual control law distribution diagram.
In step S3, visual control laws in the DCM and the CCM are acquired as training data of a second neural network, neural network output is obtained through forward propagation by taking [i_{L}, vₒ, iₒ, V_{ref}] as neural network input, and the neural network output is compared with an optimal duty cycle d^{opt}(g+l|g) obtained through EMPC, to obtain an error.

In step S4, fitting is performed on the EMPC design through the second neural network, and offline training of the second neural network is completed when the error continuously decreases to be within an allowable error range, to generate a neural network controller.

In step S5, in real-time control, a parameter of the neural network controller is extracted to a field programmable gate array (FPGA), weighted summation calculation is performed on real-time input data [i_{L}, vₒ, iₒ, V_{ref}] when the conduction mode is switched, and online adjustment is performed by the neural network controller on the duty cycle based on state sampling, to obtain a duty cycle required for controlling the Buck converter.

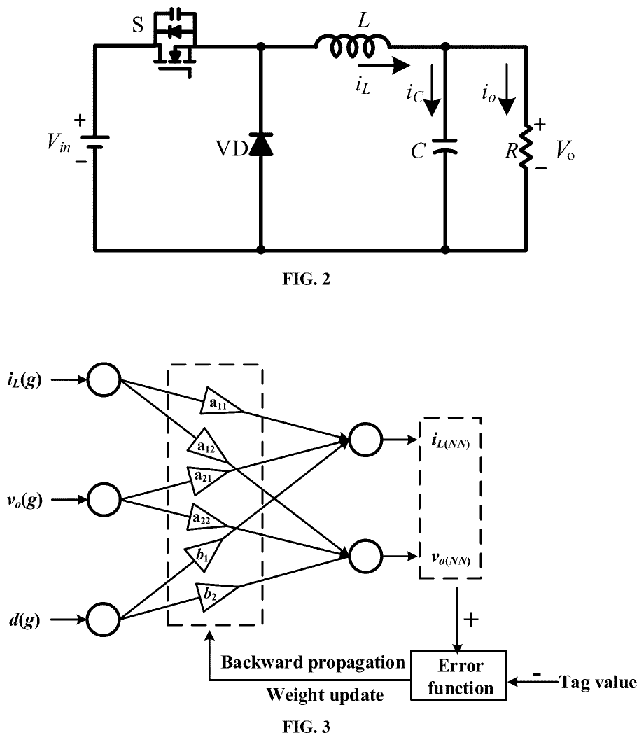

A topological structure of the Buck converter is as shown in FIG. 2.

Further, an expression formula of the state equation in step S1 is as follows:

$$[ \begin{matrix}{i}_{L} ( g + 1 ) \\ {v}_{o} ( g + 1 )\end{matrix} ] = [ \begin{matrix}{a}_{11} & {a}_{12} \\ {a}_{21} & {a}_{22}\end{matrix} ] [ \begin{matrix}{i}_{L} ( g ) \\ {v}_{o} ( g )\end{matrix} ] + [ \begin{matrix}{b}_{1} \\ {b}_{2}\end{matrix} ] d ( g ) \qquad ( 1 )$$

In the formula, i_{L}(g) and vₒ(g) respectively represent an inductive current and an output voltage at a moment g, i_{L}(g+1), vₒ(g+1), and d(g+1) respectively represent an inductive current, an output voltage, and a duty cycle at a moment g+1, and a₁₁, a₁₂, a₂₁, a₂₂, b₁, and b₂ are state coefficients of the state equation. The formula (1) is further expanded to obtain:

$$\{ \begin{matrix}{i}_{L} ( g + 1 ) = {a}_{11} \cdot {i}_{L} ( g ) + {a}_{12} \cdot {v}_{o} ( g ) + {b}_{1} \cdot d ( g ) \\ {v}_{o} ( g + 1 ) = {a}_{21} \cdot {i}_{L} ( g ) + {a}_{22} \cdot {v}_{o} ( g ) + {b}_{2} \cdot d ( g )\end{matrix} \qquad ( 2 )$$

In an operation process of the Buck converter, values of the inductive current i_{L}(g), the output voltage vₒ(g), and the duty cycle (g) in a series of DCM and CCM dynamic processes are separately stored to form a training sample, as shown in Table 1.

TABLE 1

| Group | Input | | | Tag | |
|---|---|---|---|---|---|
| 1 | i_{L}(g) | vₒ(g) | d(g) | i_{L}(g + 1) | vₒ(g + 1) |
| 2 | i_{L}(g + 1) | vₒ(g + 1) | d(g + 1) | i_{L}(g + 2) | vₒ(g + 2) |
| 3 | i_{L}(g + 2) | vₒ(g + 2) | d(g + 2) | i_{L}(g + 3) | vₒ(g + 3) |
| . | . | . | . | . | . |
| . | . | . | . | . | . |
| . | . | . | . | . | . |
| n | i_{L}(g + n) | vₒ(g + n) | d(g + n) | i_{L}(g + n + 1) | vₒ(g + n + 1) |

Further, in step S1, according to the characteristic of formula (2), i_{L}(g), vₒ(g) and d(g) are used as input data of the neural network, the state coefficient is defined as a weight of the neural network, i_{L}(g+1) and vₒ(g+1) are defined as output of a first neural network, and linear operation is performed on the input and the output without use of a bias and an activation function. An initial value of the state coefficient is random, and therefore, output i_{L}(g+1) and vₒ(g+1) of the network are not accurate, and an error function is constructed for training the weight:

TABLE 2

| | |
|---|---|
| Input | Tag |

| Group | i_{L}(g) | vₒ (g) | iₒ(g) | V_{ref}(g) | d^{opt} (g + 1\| g) |
|---|---|---|---|---|---|
| 1 | 15.1 | 64.9 | 1 | 100 | 1 |
| 2 | 45.6 | 48.8 | 1.2 | 100 | 0.9557 |
| 3 | 27.1 | 22.5 | 2 | 100 | 0.7829 |
| . | . | . | . | . | . |
| . | . | . | . | . | . |
| . | . | . | . | . | . |
| n | 21.1 | 67.5 | 2.7 | 50 | 0.3829 |

$${E}_{p a r a} = {( {i}_{L ( N N )} - {i}_{L r} )}^{2} + {( {V}_{o ( N N )} - {V}_{o r} )}^{2} \qquad ( 3 )$$

Herein i_{Lr} and Vₒᵣ are respectively tag values of corresponding beats. The linear conversion using the neural network has the advantage that the error function is adjusted to be within a specialized range through a backward propagation algorithm, to obtain a precise state model.

The first row of data in Table 1 is used as an example, i_{L}(g), vₒ(g), and d(g) are used as input of the neural network. As shown in FIG. 3, the linear operation is performed on the input to obtain output i_{L}(NN) and vₒ(NN) of the neural network; the output is compared with the tag values i_{L}(g) and vₒ(g) of the first row of data in the table according to the formula (3) to obtain an error function; backward propagation is performed by the neural network according to the error function for updating the state coefficient of the state equation, namely, the weight, to obtain the precise state model of the converter.

Further, a control objective of the EMPC design in step S2 is to adjust vₒ to a reference voltage V_{ref}, and a target function is defined as:

$${J}_{min} = {\sum }_{l = 0}^{L - 1} {q}_{1} [ {( {V}_{r e f} - {v}_{o} ( g + l \vert g ) )}^{2} + {q}_{2} {{i}_{L} ( g + l \vert g )}^{2} ] \qquad ( 4 )$$

Herein, L is a prediction period, q₁ and q₂ are penalty coefficients that are configured to fine-tune a dynamic control process, and vₒ(g+l|g) and i_{L}(g+l|g) represent prediction values at the moment g. A coordinated control item for i_{L}(g) is further added to the foregoing formula, to achieve a smooth control process. In addition, there is a need for performing EMPC design and defining corresponding constraint conditions for a state variable and a control parameter, to ensure that the variable does not exceed a physical limitation thereof, which is expressed as follows:

$$0 \leq {i}_{L} ( g ) \leq {I}_{L max} \qquad ( 5 )$$

$$0 \leq {v}_{o} ( g ) \leq {V}_{o max}$$

$$0 \leq d ( g ) \leq 1$$

Herein under a constraint condition, at a g^{th} switching period, an optimal control variable d^{opt}(g+l| g), namely, the duty cycle D of the Buck converter, in future L switching periods is obtained, to ensure a target function J to be minimal. State space is divided into M segmented areas based on the obtained control law, and each area corresponds to a group of gains and bias matrixes. When the state variable [i_{L}(g), vₒ(g)] falls in an area r, d^{opt}(g+l| g) can be calculated according to a corresponding segmented radiation function:

$${d}^{o p t} ( g + l \vert g ) = {A}_{r} \cdot [ \begin{matrix}{i}_{L} ( g ) \\ {v}_{o} ( g )\end{matrix} ] + {B}_{r} r = 1 , 2 , … , M \qquad ( 6 )$$

Herein d^{opt}(g+l| g) is the optimal control duty cycle, Aᵣ and Bᵣ are a gain and a bias matrix of the r^{th} area, that is, each segmented radiation area corresponds to a group of Aᵣ and Bᵣ.

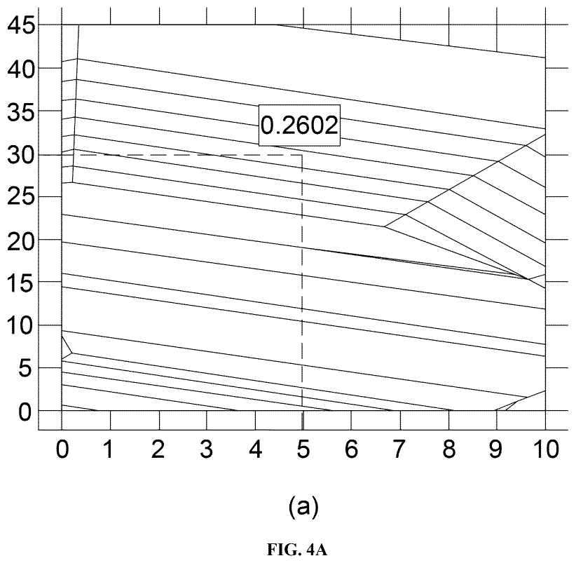

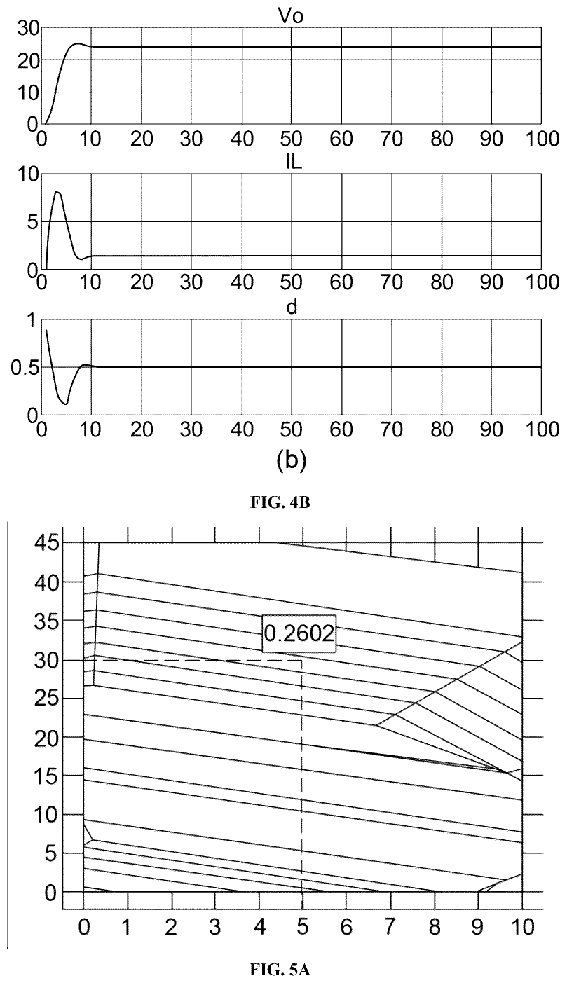

A quantity of control law areas can be adjusted through the penalty coefficient and the physical constraint. A greater quantity of segmented radiation areas indicates higher control precision. According to a dynamic operation process of the Buck converter, let a target output voltage be 24 V and penalty coefficients be q₁=q₂=100. As shown in FIGS. 4A-4B, FIG. 4A shows a control law of the EMPC, and FIG. 4B is a schematic diagram of a predication effect of the EMPC. It is assumed that the state variable [i_{L}(g), vₒ(g)] is [5, 30], the optimal control duty cycle d^{opt}(g+l| g) corresponding to the area is calculated as 0.2602 according to the formula (6). The d^{opt}(g+l| g) acts in a next switching period of the Buck converter.

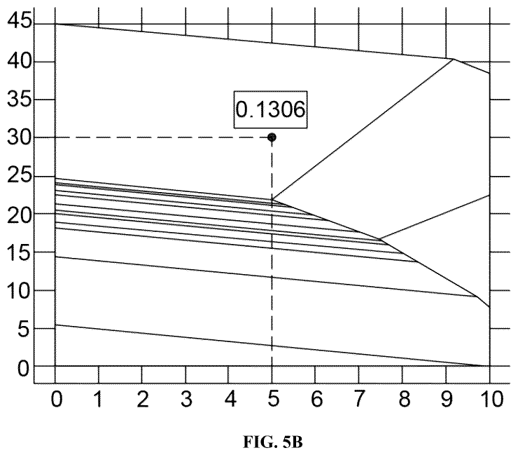

Further, in step S3, a control rate needs to be sampled for the neural network controller to fit to the EMPC law, that is, a group of specific [i_{L}(g), vₒ(g)] is input. An area in which the group of working points is located is determined, the gain Aᵣ and the bias matrix Bᵣ corresponding to the area are extracted, and the corresponding optimal control duty cycle is calculated according to the formula (6), where [i_{L}(g), vₒ(g)], and d^{opt}(g+l|g) form one training sample. As shown in FIGS. 5A-5B, when [i_{L}(g), vₒ(g)] is [5, 30], different working points correspond to different d^{opt}(g+l|g), which are 0.2602 and 0.1306, as shown in Table 2. To distinguish control rates under different working conditions, two extra dimensions need to be introduced, therefore, the sample structure is changed into four-dimensional input [i_{L}(g), vₒ(g), iₒ(g), V_{ref}(g)]. This ensures that a unique correspondence between input and output under different working points, and enriches input information amount.

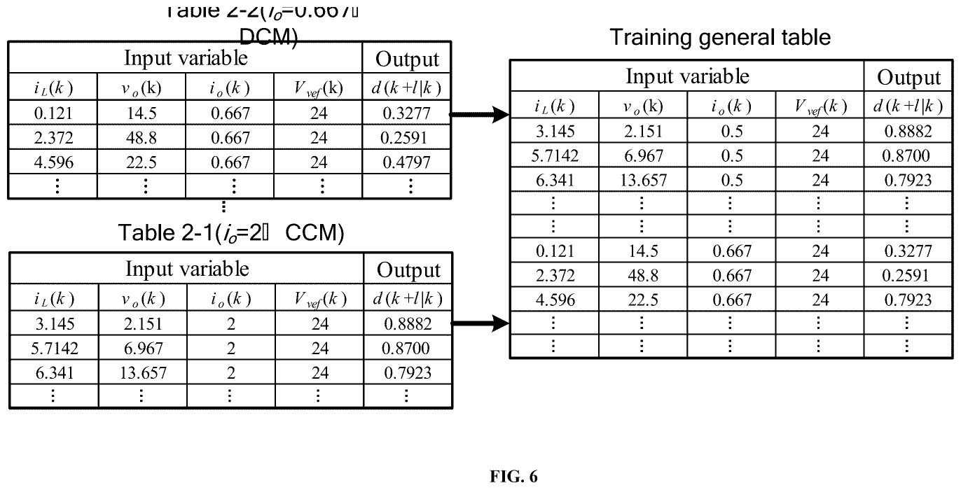

Further, step S3 further includes: EMPC control laws of the Buck converter under the DCM and CCM working conditions are separately sampled according to step S1 to step S3. As shown in FIG. 6, the control laws under different working conditions form one training set which is introduced into the neural network for training.

Further, in step S4, the second neural network is designed as follows: One fully-connected neural network usually includes one input layer, one or more hidden layers, and one output layer. A neural network with a plurality of hidden layers is referred to as a “depth neural network”, and a neural network with a single hidden layer having a large quantity of neurons is referred to as a “width neural network”. Compared with the depth neural network, the width neural network has shorter computing time, so that online computing time is shortened to a greatest extent. Therefore, the second neural network in the present disclosure adopts a width neural network structure. FIG. 7 shows a propagation process of a neural network according to the present disclosure.

At an input layer: Before [i_{L}(g), vₒ(g), iₒ(g), V_{ref}(g)] is introduced into the second neural network, input data is firstly normalized as xₘ(j)(m=1, 2, 3, 4) which is represented as

$${x}_{m} ( j ) = \frac{2 x - 2 {X}_{min}}{{X}_{max} - {X}_{min}} - 1 ,$$

where x is an actual value in one-dimensional input, and Xₘₐₓ (Xₘᵢₙ) is a maximum value (a minimum value) in one-dimensional input.

At a hidden layer: Linear operation, namely, weighted summation calculation, is firstly performed on the input by a neuron at the hidden layer, a linear operation result is transferred to a nonlinear activation function to obtain output at the hidden layer:

$${O}_{h} = φ ( {\sum }_{k = 1}^{n} {w}_{ij} {x}_{m} ( j ) + {B}_{ij} ) ,$$

where wᵢⱼ represents a weight between a j^{th} neuron at the input layer and an i^{th} neuron at the hidden layer, and Bᵢⱼ represents a bias between the j^{th} neuron at the input layer and the i^{th} neuron at the hidden layer.

At an output layer: Weighted summation calculation is firstly performed on the output at the hidden layer, and then the activation function φ(x) is used to obtain output at the output layer:

$${O}_{out} = φ ( {\sum }_{k = 1}^{n} {w}_{li} {O}_{h} + {B}_{li} ) ,$$

where w₁ᵢ represents a weight between the i^{th} neuron at the hidden layer and a l^{th} neuron at the output layer, and B₁ᵢ represents a bias between the i^{th} neuron at the hidden layer and the l^{th} neuron at the output layer.

The activation function is a key for the neural network to convert linear combination into a nonlinear relationship. Both the activation functions at the hidden layer and the output layer are ReLU functions, so that a few resources are occupied by a digital controller, and an expression formula of the ReLU function is:

$$Re LU ( x ) = \{ \begin{matrix}0 & x \leq 0 \\ x & x > 0\end{matrix} .$$

In this embodiment, step S4 further includes the following steps.

In the neural network, forward propagation and error backward propagation are alternately performed. After each forward propagation, an error is calculated, a weight in the neural network is adjusted in a negative gradient direction, and an error function is propagated back to each layer of the neural network to adjust the weight. In the present disclosure, a second error function is defined as:

$$E ( k ) = {[ {d}^{opt} ( g + 1 \vert g ) - {D}_{NN} ( g + 1 \vert g ) ]}^{2} ,$$

where D_{NN}(g+1|g) is an output value of the neural network.

Negative gradient correction is performed on the weight W at each layer by using the obtained error function, and an increment of a weight coefficient at each layer may be represented as:

$$w ( j + 1 ) = w ( j ) - λ \frac{\partial E ( k )}{\partial w} ,$$

where λ represents a learning rate. The learning rate determines a step size for weight update, that is, during each iteration, an amplitude of the weight is adjusted in the network based on a gradient of a loss function.

During the error backward propagation, the weight is updated continuously, and the weight is modified in compliance with a chain rule, which is represented as follows:

$$\frac{\partial E ( k )}{\partial w} = \frac{\partial E ( k )}{\partial τ} \cdot \frac{\partial τ}{\partial w} ,$$

where τ is the activation function at the hidden layer or output layer. A bias correction process is consistent with a weight correction process. Details are not described here again. As the training is performed, if the error function continuously decreases to be stable, it indicates that a training result of the network reaches an expected performance requirement.

Further, step S5 includes the following steps.

As shown in FIG. 9, the neural network parameters (the weight and the bias) which are offline-trained in step S4 are extracted to the FPGA, the neural network is run in the FPGA, and computing such as weighted summation is performed on input data [i_{L}(g), vₒ(g), iₒ(g), V_{ref}(g)], to obtain a duty cycle required for controlling the Buck converter.

According to the control method in the present disclosure, control simulation is performed on the Buck converter, and parameters of the converter are shown in Table 3.

TABLE 3

| Parameter | Value | |
|---|---|---|
| Input voltage Vᵢₙ | 48 | V |
| Output voltage Vₒ | 24 | V |
| Full-load power Pₒ | 48 | W |
| Frequency fₛ | 100 | kHZ |
| Inductance L | 483 | μH |
| Capacitance C | 220 | μF |

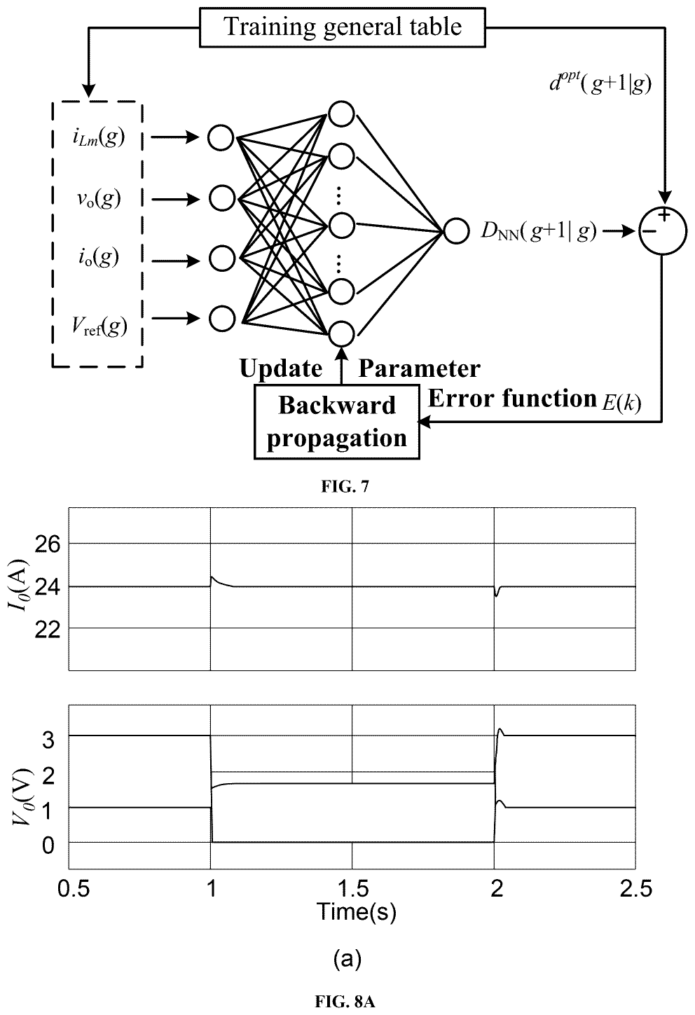

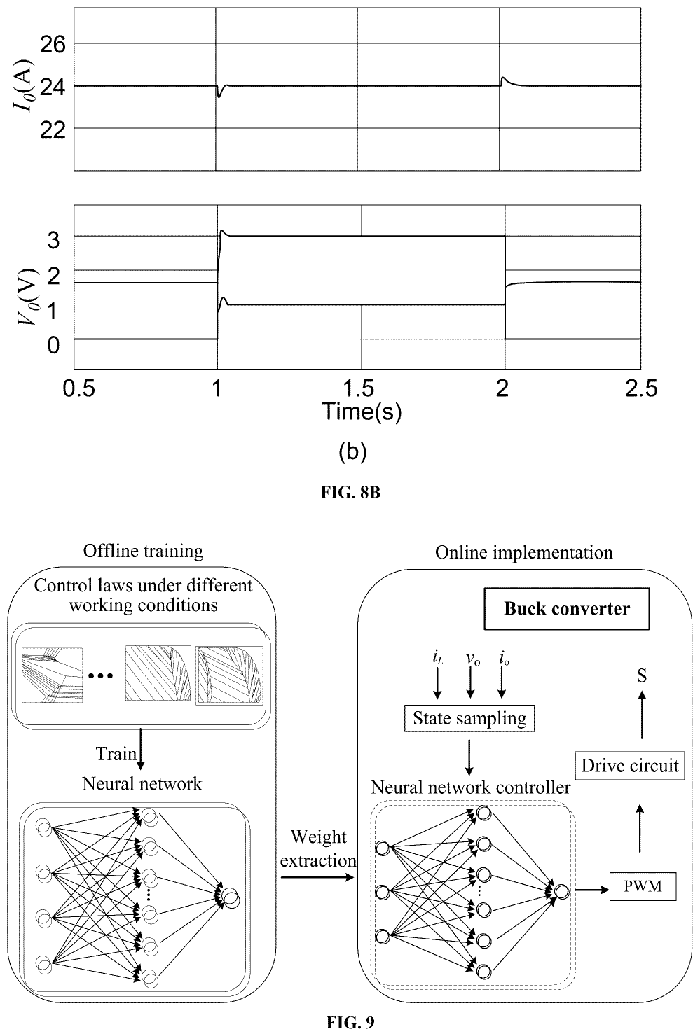

Penalty coefficients of the EMPC are q₁=30, and q₂=3000, there are 20 neurons in the second neural network, and the learning rate is 0.01. As shown in FIGS. 8A-8B, FIG. 8A is a simulation diagram of an output voltage and an inductive current when an output current is form 2 A to 0.667 A, and then to 2 A (CCM-DCM-CCM). It can be seen that, when the mode is switched, recovery time of the output voltage is 0.12 ms, and a voltage overshoot is 0.452 V; and FIG. 8B is a simulation diagram of an output voltage and an inductive current when an output current is from 0.667 A to 2 A, and then to 0.667 A (DCM-CCM-DCM), where time for reaching a steady state is 0.055 ms, and a voltage overshoot is 0.071 V. It can be seen that, the control policy in the present disclosure is used, so that precision of the output voltage of the Buck converter during DCM/CCM switching is improved, time for reaching a steady state is short, and an overshoot is small.

The above merely describes preferred specific implementations of the present application, but a protection scope of the present application is not limited thereto. Any person skilled in the art can easily conceive modifications or replacements within the technical scope of the present application, and these modifications or replacements shall fall within the protection scope of the present application. Therefore, the protection scope of the present disclosure should be subject to the protection scope of the claims.

What is claimed is:

1. A neural network-based control method for switching a conduction mode of a Buck converter, comprising:
S1, establishing a state-space averaging model of the Buck converter, acquiring and substituting output voltages vₒ and inductive currents i_{L} of the Buck converter in a discontinuous conduction mode (DCM) and a continuous conduction mode (CCM) into a state equation, and obtaining, based on a characteristic of a discrete equation and a backward propagation characteristic of a neural network, a precise state model under different working conditions;
S2, performing an explicit model predictive control (EMPC) design based on the state model for dynamic performance of the Buck converter to be optimal, to generate a visual control law distribution diagram;
S3, acquiring visual control laws in the DCM and the CCM as training data of a second neural network, obtaining neural network output through forward propagation by taking [i_{L}, vₒ, iₒ, V_{ref}] as neural network input, and comparing the neural network output with an optimal duty cycle d^{opt}(g+l|g) obtained through EMPC, to obtain an error;
S4, performing fitting on the EMPC design through the second neural network, and completing offline training of the second neural network when the error continuously decreases to be within an allowable error range, to generate a neural network controller; and
S5, in real-time control, extracting a parameter of the neural network controller to a field programmable gate array (FPGA), performing weighted summation calculation on real-time input data [i_{L}, vₒ, iₒ, V_{ref}] when switching the conduction mode, and performing, by the neural network controller based on state sampling, online adjustment on the duty cycle, to obtain a duty cycle required for controlling the Buck converter.

2. The neural network-based control method for switching a conduction mode of a Buck converter according to claim 1, wherein an expression formula of the state equation in step S1 is as follows:
$$[ \begin{matrix}{i}_{L} ( g + 1 ) \\ {v}_{o} ( g + 1 )\end{matrix} ] = [ \begin{matrix}{a}_{11} & {a}_{12} \\ {a}_{21} & {a}_{22}\end{matrix} ] [ \begin{matrix}{i}_{L} ( g ) \\ {v}_{o} ( g )\end{matrix} ] + [ \begin{matrix}{b}_{1} \\ {b}_{2}\end{matrix} ] d ( g ) ,$$
wherein i_{L}(g) and vₒ(g) respectively represent an inductive current and an output voltage at a moment g, i_{L}(g+1), vₒ(g+1), and d(g+1) respectively represent an inductive current, an output voltage, and a duty cycle at a moment g+1, and a₁₁, a₁₂, a₂₁, a₂₂, b₁, and b₂ are state coefficients of the state equation.

3. The neural network-based control method for switching a conduction mode of a Buck converter according to claim 2, wherein the obtaining, based on a characteristic of a discrete equation and a backward propagation characteristic of a neural network, a precise state model under different working conditions comprises:
inputting the inductive current, the output voltage, and the duty cycle into the neural network, defining the state coefficient as a weight of the neural network, obtaining output of a first neural network, performing linear operation on the input and the output, constructing an error function, and adjusting the error function to be within a specified range through backward propagation, to obtain the precise state model under different working conditions.

4. The neural network-based control method for switching a conduction mode of a Buck converter according to claim 1, wherein a control objective for performing the EMPC design on different models is to adjust vₒ to a reference voltage V_{ref}, and a target function is defined as follows:
$${J}_{min} = {\sum }_{l = 0}^{L - 1} {q}_{1} [ {( {V}_{ref} - {v}_{o} ( g + l \vert g ) )}^{2} + {q}_{2} {{i}_{L} ( g + l \vert g )}^{2} ] ,$$
wherein
L is a prediction period, q₁ and q₂ are penalty coefficients that are configured to fine-tune a dynamic control process, and vₒ(g+1|g) and i_{L}(g+1|g) represent prediction values at a moment g.

5. The neural network-based control method for switching a conduction mode of a Buck converter according to claim 1, wherein a corresponding constraint condition for a state variable and a control parameter during the EPMC design comprises:
$$0 \leq {i}_{L} ( g ) \leq {I}_{L max}$$
$$0 \leq {v}_{o} ( g ) \leq {V}_{o max}$$
$$0 \leq d ( g ) \leq 1 ,$$
wherein i_{L}(g), vₒ(g), and d(g) respectively represent an inductive current, an output voltage, and a duty cycle at a moment g.

6. The neural network-based control method for switching a conduction mode of a Buck converter according to claim 1, wherein a process of obtaining neural network output through forward propagation by taking [i_{L}, vₒ, iₒ, V_{ref}] as neural network input comprises:
at an input layer: before introducing [i_{L}(g), vₒ(g), iₒ(g), V_{ref}(g)] into the second neural network, normalizing input data as xₘ(j)(m=1, 2, 3, 4) which is represented as
$${x}_{m} ( j ) = \frac{2 x - 2 {X}_{min}}{{X}_{max} - {X}_{min}} - 1 ,$$
wherein X is an actual value of one-dimensional input, Xₘₐₓ is a maximum value in one-dimensional input, and Xₘᵢₙ is a minimum value in one-dimensional input;
at a hidden layer: performing, by a neuron at the hidden layer, linear operation, namely, weighted summation calculation, on the input, transferring a linear operation result to a nonlinear activation function to obtain output at the hidden layer:
$${O}_{h} = φ ( {\sum }_{k = 1}^{n} {w}_{ij} {x}_{m} ( j ) + {B}_{ij} ) ,$$
wherein wᵢⱼ represents a weight between a j^{th} neuron at the input layer and an i^{th} neuron at the hidden layer, and Bᵢⱼ represents a bias between the j^{th} neuron at the input layer and the i^{th} neuron at the hidden layer;
at an output layer: firstly performing weighted summation calculation on the output at the hidden layer, and then using the activation function φ(x) to obtain output at the output layer:
$${O}_{out} = φ ( {\sum }_{k = 1}^{n} {w}_{li} {O}_{h} + {B}_{li} ) ,$$
wherein wₗᵢ represents a weight between the i^{th} neuron at the hidden layer and a l^{th} neuron at the output layer, and Bₗᵢ represents a bias between the i^{th} neuron at the hidden layer and the l^{th} neuron at the output layer; and
both the activation functions at the hidden layer and the output layer are ReLU functions, so that a few resources are occupied by a digital controller, and an expression formula of the ReLU function is:
$$Re LU ( x ) = \{ \begin{matrix}0 & x \leq 0 \\ x & x > 0\end{matrix} , x ,$$
wherein
x is data obtained through weighted summation at the hidden layer or the output layer.

7. The neural network-based control method for switching a conduction mode of a Buck converter according to claim 1, wherein a weight and a bias are corrected through a gradient descent method and a chain rule, and the completing offline training of the second neural network when the error continuously decreases to be within an allowable error range comprises:
defining an error function as:
$${E}_{off} = {[ {d}^{opt} ( g + 1 \vert g ) - {D}_{NN} ( g + 1 \vert g ) ]}^{2} ,$$
wherein
d^{opt}(g+1|g) is the optimal duty cycle obtained through the EMPC, D_{NN}(g+1|g) is a neural network output value, the weight and the bias of the neural network are adjusted layer by layer through the gradient descent method from the input layer to the output layer, d^{opt}(g+1|g) and D_{NN}(g+1| g) are compared to obtain the error function E(k) according to the chain rule:
$$\frac{\partial E ( k )}{\partial w} = \frac{\partial E ( k )}{\partial τ} \cdot \frac{\partial τ}{\partial w} ,$$
wherein
τ is the activation function at the hidden layer or the output layer; and
an obtained gradient is multiplied with a learning rate λ, to update the original weight w as:
$$w ( j + 1 ) = w ( j ) - λ \frac{\partial E ( k )}{\partial w} ,$$
wherein
w(j+1) and w(j) respectively represent weights at a moment j+1 and a moment j, the learning rate λ determines a step size for weight update, that is, during each iteration, an amplitude of the weight is adjusted in the network based on a gradient of a loss function.
